(19) United States
(12) Patent Application Publication
(10) Pub. No.: US 2025/0269962 A1
(43) Pub. Date: Aug. 28, 2025

(54) FLAME EFFECT SYSTEM FOR AN UNMANNED AERIAL VEHICLE

(71) Applicant: Universal City Studios LLC, Universal City, CA (US)

(72) Inventor: Ronald Joseph Keller, JR., Orlando, FL (US)

(21) Appl. No.: 18/901,731

(22) Filed: Sep. 30, 2024

Related U.S. Application Data
(60) Provisional application No. 63/556,917, filed on Feb. 23, 2024.

(51) Int. Cl. B64D 7/00; B64U 10/14; B64U 50/19; B64U 50/30; B64U 101/18

(52) U.S. Cl. CPC B64D 7/00; B64U 10/14; B64U 50/19; B64U 50/30; B64U 2101/18

(57) ABSTRACT

A flame effect system for an unmanned aerial vehicle (UAV) includes a hopper configured to store a powdered fuel, a propellant tank configured to store a propellant, and a nozzle configured to expel the powdered fuel into an atmosphere. Furthermore, the flame effect system includes a fluid path extending from the propellant tank to the nozzle. The hopper is fluidly coupled to the fluid path at an intersection between the propellant tank and the nozzle, the hopper is configured to enable the powdered fuel to flow into the fluid path, and the propellant tank is configured to expel the propellant through the fluid path to fluidize the powdered fuel within the fluid path and to drive the fluidized powdered fuel through the nozzle.

### CROSS-REFERENCE TO RELATED APPLICATION

This application claims priority from and the benefit of U.S. Provisional Application Ser. No. 63/556,917, entitled “FLAME EFFECT SYSTEM FOR AN UNMANNED AERIAL VEHICLE”, filed Feb. 23, 2024, which is hereby incorporated by reference in its entirety.

### BACKGROUND

The present disclosure relates generally to a flame effect system for an unmanned aerial vehicle.

Certain unmanned aerial vehicles (UAVs) (e.g., drones) include a flame emitting system, which may be used to initiate controlled burns for forest management. The flame emitting system may include a tank configured to contain liquid fuel (e.g., gasoline, kerosene, etc.), a pump, a nozzle, and an ignition system. The pump may drive the liquid fuel to flow from the tank to the nozzle. The nozzle may aerosolize the liquid fuel and the ignition system may ignite the aerosolized fuel, thereby establishing a combustion reaction. To reduce the possibility of fuel leakage in the event of an unexpectedly forceful landing of the UAV, the flame emitting system may include a thick-walled tank and one or more valves configured to selectively block fuel flow from the tank. Due to the thick-walled tank, the valve(s), and the pump, the flame emitting system may have significant weight. As a result of the weight of the flame emitting system, a UAV with a large lift capacity may be used to support the flame emitting system. Due to the costs associated with such a large lift capacity UAV and the costs associated with the thick-walled tank and the valve(s) of the flame emitting system, a UAV having a flame emitting system may be prohibitively expensive for certain applications.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the claimed subject matter. Indeed, the claimed subject matter may encompass a variety of forms that may be similar to or different from the embodiments set forth below.

In certain embodiments, a flame effect system for an unmanned aerial vehicle includes a hopper configured to store a powdered fuel, a propellant tank configured to store a propellant, and a nozzle configured to expel the powdered fuel into an atmosphere. Furthermore, the flame effect system includes a fluid path extending from the propellant tank to the nozzle. The hopper is fluidly coupled to the fluid path at an intersection between the propellant tank and the nozzle. The hopper is configured to enable the powdered fuel to flow into the fluid path, and the propellant tank is configured to expel the propellant through the fluid path to fluidize the powdered fuel within the fluid path and to drive the fluidized powdered fuel through the nozzle.

Furthermore, in certain embodiments, an unmanned aerial vehicle includes a body, at least one electric motor coupled to the body, at least one propeller coupled to the at least one electric motor, a battery coupled to the body and electrically coupled to the at least one electric motor, and a flame effect system coupled to the body. The flame effect system includes a hopper configured to store a powdered fuel, a propellant tank configured to store a propellant, a nozzle configured to expel the powdered fuel into an atmosphere, and a fluid path extending from the propellant tank to the nozzle. The hopper is fluidly coupled to the fluid path at an intersection between the propellant tank and the nozzle. The hopper is configured to enable the powdered fuel to flow into the fluid path, and the propellant tank is configured to expel the propellant through the fluid path to fluidize the powdered fuel within the fluid path and to drive the fluidized powdered fuel through the nozzle.

In addition, in certain embodiments, a flame effect system for an unmanned aerial vehicle includes a hopper configured to store a powdered fuel, a propellant tank configured to store a propellant, a nozzle configured to expel the powdered fuel into an atmosphere, and a fluid path extending from the propellant tank to the nozzle. The hopper is fluidly coupled to the fluid path at an intersection between the propellant tank and the nozzle, and the hopper is configured to enable the powdered fuel to flow into the fluid path. The flame effect system also includes a valve disposed along the fluid path between the propellant tank and the intersection. The valve is configured to selectively open to facilitate flow of the propellant through the fluid path to fluidize the powdered fuel within the fluid path and to drive the fluidized powdered fuel through the nozzle. Furthermore, the flame effect system includes an igniter positioned at or proximate to the nozzle. The igniter is configured to activate to initiate a combustion reaction between the fluidized powdered fuel and oxygen in the atmosphere. In addition, the flame effect system includes a controller communicatively coupled to the valve and to the igniter. The controller includes a memory and a processor, and the controller is configured to instruct the valve to open and the igniter to activate to initiate the combustion reaction.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of an unmanned aerial vehicle (UAV) having a flame effect system;

FIG. 2 is a schematic view of the UAV of FIG. 1; and

FIG. 3 is a schematic view of an embodiment of a flame effect system that may be employed within the UAV of FIG. 1.

### DETAILED DESCRIPTION

One or more specific embodiments of the present disclosure will be described below. To provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

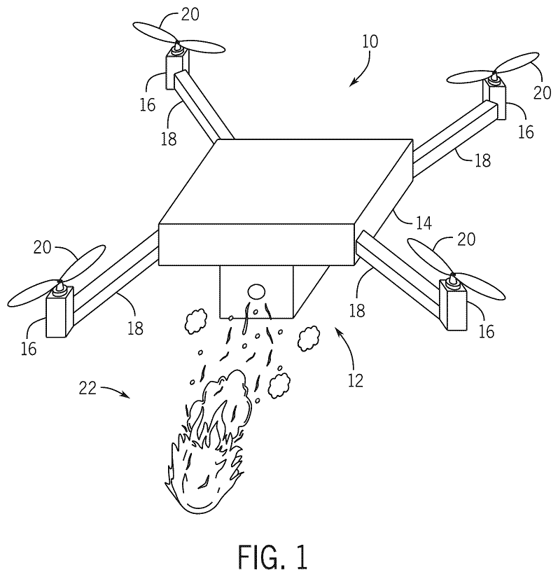

FIG. 1 is a perspective view of an embodiment of an unmanned aerial vehicle (UAV) 10 (e.g., drone) having a flame effect system 12. As illustrated, the UAV 10 includes a body 14 and multiple electric motors 16 coupled to the body 14. In the illustrated embodiment, each electric motor 16 is coupled to the body 14 by a respective arm 18. However, in other embodiments, at least one electric motor (e.g., each electric motor) may be coupled to the body by any suitable structure (e.g., framework, truss assembly, etc.). Furthermore, the UAV 10 includes multiple propellers 20 coupled to the electric motors 16. In the illustrated embodiment, one propeller 20 is coupled to each electric motor 16. However, in other embodiments, multiple propellers may be coupled to a single electric motor, and/or multiple electric motors may drive a single propeller. In the illustrated embodiment, the UAV 10 includes four electric motors 16 and four propellers 20. However, in other embodiments, the UAV may include more or fewer electric motors, and/or more or fewer propellers.

As discussed in detail below, the UAV 10 includes a battery electrically coupled to the electric motors 16 and configured to provide electrical power to the electric motors 16. The battery may be coupled to the body 14 (e.g., disposed within a cavity of the body, coupled to an exterior surface of the body, etc.). The UAV 10 includes a controller configured to control the electric motors 16, thereby controlling movement of the UAV 10. For example, in certain embodiments, the controller may control the rotational speed of each electric motor 16, thereby controlling the altitude, the attitude, and the direction of movement of the UAV 10.

As illustrated, the flame effect system 12 is coupled to the body 14, and the flame effect system 12 is configured to selectively generate a flame effect 22. As discussed in detail below, the flame effect system 12 includes a hopper configured to store a powdered fuel (e.g., lycopodium powder, etc.), and the flame effect system 12 includes a propellant tank configured to store a propellant (e.g., carbon dioxide, etc.). The flame effect system 12 also includes a nozzle configured to expel the powdered fuel into the atmosphere. Furthermore, the flame effect system 12 includes a fluid path extending from the propellant tank to the nozzle. The hopper is fluidly coupled to the fluid path at an intersection between the propellant tank and the nozzle, and the hopper is configured to enable the powdered fuel to flow into the fluid path under the influence of gravity. In addition, the propellant tank is configured to expel the propellant through the fluid path to fluidize the powdered fuel and to drive the powdered fuel through the nozzle. In certain embodiments, the flame effect system 12 also includes an igniter positioned at or proximate to the nozzle. The igniter is configured to activate to initiate a combustion reaction between the powdered fuel and oxygen in the atmosphere, thereby generating the flame effect 22.

While the UAV 10 includes a single flame effect system 12 in the illustrated embodiment, in other embodiments, the UAV may include multiple flame effect systems (e.g., 2, 3, 4, or more). For example, in certain embodiments, the UAV may include one flame effect system configured to generate a flame effect in a first direction (e.g., forward direction) and another flame effect system configured to generate a flame effect in a second direction (e.g., rearward direction). Furthermore, in certain embodiments, the UAV may include multiple flame effect systems configured to generate multiple flame effects in a single direction.

The UAV 10 with the flame effect system 12 may be used as part of an aerial performance that incorporates UAV movement with flame effects. For example, multiple UAVs, each having a flame effect system, may be operated in a coordinated aerial performance. Because the flame effect system uses powdered fuel to generate the flame effect, the need for a thick-walled tank for storage of a liquid fuel (e.g., to reduce the possibility of fuel leakage in the event of an unexpectedly forceful landing of the UAV) is obviated, and the weight of the flame effect system may be reduced (e.g., as compared to a liquid fuel flame effect system), thereby reducing the size and the cost of the UAV. In addition, if the UAV experiences an unexpectedly forceful landing sufficient to enable the powdered fuel to leak onto the ground, the powdered fuel may be effectively non-flammable (e.g., because the powdered fuel in a pile on the ground may not receive sufficient oxygen to ignite).

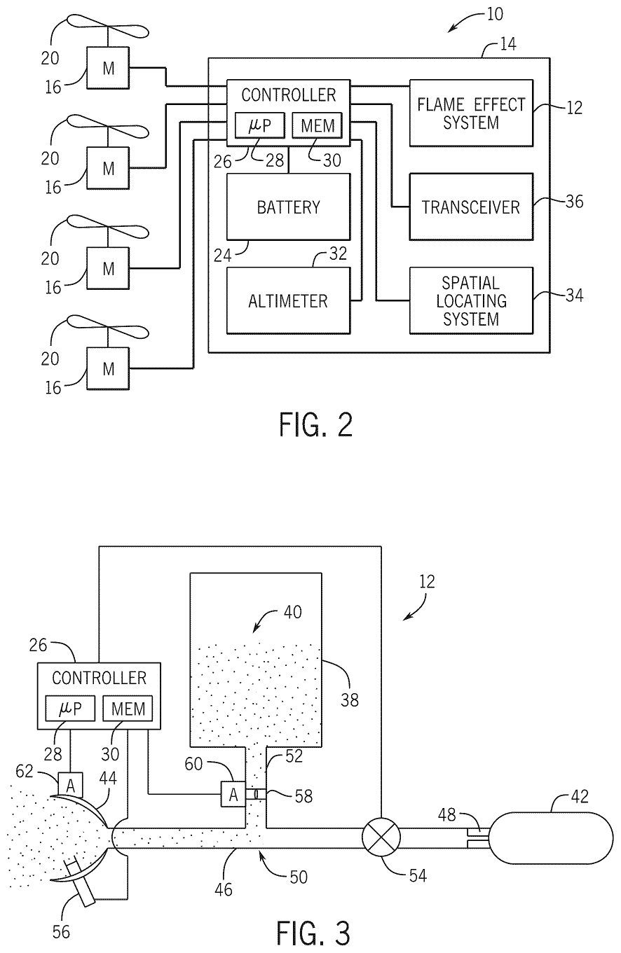

FIG. 2 is a schematic view of the UAV 10 of FIG. 1. As previously discussed, the UAV 10 includes multiple electric motors 16 coupled to the body 14, and the UAV 10 includes multiple propellers 20 coupled to the electric motors 16. The electric motors 16 are configured to drive the propellers 20 to rotate, thereby controlling movement of the UAV 10. In the illustrated embodiment, the UAV 10 includes a battery 24 coupled to the body 14 and electrically coupled to the electric motors 16. The battery 24 is configured to provide electrical power to the electric motors 16, thereby enabling the electric motors 16 to drive the propellers 20 to rotate. In certain embodiments, the battery 24 is rechargeable, and the UAV includes an electrical connector configured to establish an electrical connection to a power source, thereby facilitating recharging the battery 24. Additionally or alternatively, the battery may be removable, thereby enabling an operator to replace the battery to facilitate continued operation of the UAV. As previously discussed, the flame effect system 12 is coupled to the body 14 and configured to generate a flame effect.

In the illustrated embodiment, the UAV 10 includes a controller 26 communicatively coupled to the electric motors 16 and to the flame effect system 12. In certain embodiments, the controller 26 may be part of the flame effect system 12. As illustrated, the controller 26 is coupled to the body 14 of the UAV 10. For example, the controller 26 may be disposed within a cavity of the body 14, or the controller 26 may be coupled to an exterior surface of the body 14. As discussed in detail below, the controller 26 is configured to control the electric motors 16 to control movement of the UAV 10, as well as to control the flame effect system 12 to control the flame effect. In certain embodiments, the controller 26 is an electronic controller having electrical circuitry configured to control the electric motors 16 and the flame effect system 12. In the illustrated embodiment, the controller 26 includes a processor, such as the illustrated microprocessor 28. The controller 26 may also include one or more storage devices such as the illustrated memory device 30 and/or other suitable components. The processor 28 may be used to execute software, such as software for controlling the electric motors 16, the flame effect system 12, and so forth. Moreover, the processor 28 may include multiple microprocessors, one or more “general-purpose” microprocessors, one or more special-purpose microprocessors, one or more application specific integrated circuits (ASICs), one or more reduced instruction set (RISC) processors. or some combination thereof.

The memory device 30 may include a volatile memory such as random access memory (RAM), and/or a nonvolatile memory such as read-only memory (ROM). The memory device 30 may store a variety of information and may be used for various purposes. For example, the memory device 30 may store processor-executable instructions (e.g., firmware or software) for the processor 28 to execute, such as instructions for controlling the electric motors 16, the flame effect system 12, and so forth. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the electric motors 16, the flame effect system 12, etc.), and any other suitable data.

As illustrated, the battery 24 is electrically coupled to the controller 26 and is configured to provide electrical power to the controller 26. Accordingly, the battery 24 is electrically coupled to the electric motors 16 via the controller 26. In addition, the controller 26 is configured to control the rotational speed of each electric motor 16, thereby controlling the altitude, the attitude, and the direction of movement of the UAV 10. In certain embodiments, the UAV may include one or more actuators configured to control an orientation of one or more electric motors. In such embodiments, the controller may be communicatively coupled to the actuator(s), and the controller may control the actuator(s) and the speed of the electric motors to control the altitude, the attitude, and the direction of movement of the UAV.

In the illustrated embodiment, the UAV 10 includes an altimeter 32 communicatively coupled to the controller 26. In certain embodiments, the altimeter 32 is coupled to the body 14 (e.g., disposed within a cavity of the body, coupled to an exterior surface of the body, etc.). The altimeter 32 is configured to output an altitude signal indicative of the altitude of the UAV 10. The controller 26 is configured to determine the altitude of the UAV 10 based on feedback from the altimeter 32.

In the illustrated embodiment, the UAV 10 includes a spatial locating system 34 communicatively coupled to the controller 26. In certain embodiments, the spatial locating system 34 is coupled to the body 14 (e.g., disposed within a cavity of the body, coupled to an exterior surface of the body, etc.). The spatial locating system 34 is configured to output a position signal indicative of a position, an orientation, a linear velocity, an angular velocity, or a combination thereof, of the UAV 10. The controller 26 is configured to determine the position, the orientation, the linear velocity, the angular velocity, or a combination thereof, of the UAV 10 based on feedback from the spatial locating system 34. The spatial locating system 34 may include any suitable spatial locating device(s), such as a global positioning system (GPS) receiver.

While the UAV includes the altimeter 32 and the spatial locating system 34 in the illustrated embodiment, in other embodiments, the altimeter and/or the spatial locating system may be omitted. Furthermore, in certain embodiments, the UAV may include one or more other sensors configured to provide position and/or orientation feedback to the controller. For example, in certain embodiments, the UAV may include a gyroscopic sensor (e.g., solid-state gyroscope, etc.), an inertial navigation sensor, a RADAR sensor, a LiDAR sensor, other suitable sensor(s), or a combination thereof. In addition, in certain embodiments, the UAV may include an impact sensor, a camera, an infrared sensor, other suitable sensor(s), or a combination thereof. Each sensor may be communicatively coupled to the controller and configured to output respective sensor signal(s) to the controller.

In the illustrated embodiment, the UAV 10 includes a transceiver 36 communicatively coupled to the controller 26. In certain embodiments, the transceiver 36 is coupled to the body 14 (e.g., disposed within a cavity of the body, coupled to an exterior surface of the body, etc.). The transceiver 36 is configured to receive input from a remote operator and/or a remote base station, and/or output data to the remote operator and/or the remote base station. For example, in certain embodiments, the transceiver 36 may receive input signal(s) for controlling movement of the UAV 10 (e.g., discrete movement controls, a flightpath, etc.) and/or for controlling the flame effect system 12 (e.g., discrete activation and/or deactivation commands, a plan including location(s) and/or time(s) for activating and/or deactivating the flame effect system, etc.). Additionally or alternatively, the transceiver 36 may output signal(s) indicative of the position and/or the orientation of the UAV 10, the operational status of the UAV 10, the state (e.g., activated, deactivated) of the flame effect system 12, the operational status of the flame effect system, other suitable parameter(s), or a combination thereof. While the UAV includes the transceiver 36 in the illustrated embodiment, in other embodiments, the transceiver may be omitted. In such embodiments, the controller may operate the UAV based on a stored flightpath and a flame effect system plan.

As discussed in detail below, the flame effect system 12 includes a hopper configured to store a powdered fuel (e.g., lycopodium powder, etc.), and the flame effect system 12 includes a propellant tank configured to store a propellant (e.g., carbon dioxide). In addition, the flame effect system 12 includes a nozzle configured to expel the powdered fuel into the atmosphere, and the flame effect system 12 includes a fluid path extending from the propellant tank to the nozzle. The hopper is fluidly coupled to the fluid path at an intersection between the propellant tank and the nozzle, and the hopper is configured to enable the powdered fuel to flow into the fluid path under the influence of gravity. In certain embodiments, the flame effect system 12 includes a valve disposed along the fluid path between the propellant tank and the intersection. The valve is configured to selectively open to facilitate flow of the propellant through the fluid path to fluidize the powdered fuel and to drive the powdered fuel through the nozzle. In certain embodiments, the flame effect system 12 includes an igniter positioned at or proximate to the nozzle. The igniter is configured to activate to initiate a combustion reaction between the powdered fuel and the oxygen in the atmosphere, thereby generating the flame effect.

In addition, as discussed in detail below, the controller 26 is communicatively coupled to the valve and to the igniter of the flame effect system 12. The controller 26 is configured to instruct the valve to open and the igniter to activate (e.g., for a selected duration) to initiate the combustion reaction. In addition, the controller is configured to instruct the valve to close to terminate the combustion reaction. Accordingly, the controller 26 may selectively activate and deactivate the flame effect system 12 during operation of the UAV 10. In certain embodiments, the controller 26 may activate the flame effect system 12 in response to receiving a control signal via the transceiver 36. For example, an operator or an automated control system at a base station may cause the base station to output a signal to the UAV 10 indicative of instructions to activate the flame effect system 12, and the controller 26 may activate the flame effect system 12 in response to receiving the signal via the transceiver 36. Furthermore, in certain embodiments, a plan for operating the flame effect system 12 may be stored within the controller 26. For example, the plan may be received from the base station via the transceiver, and/or the plan may be received from a device (e.g., computer, tablet, mobile storage device, etc.) connected to the controller by a wired connection and/or a wireless connection. The plan may include instructions to activate and/or deactivate the flame effect system 12 based on the position of the UAV, the orientation of the UAV, a particular time, or a combination thereof.

In certain embodiments, the controller 26 is configured to deactivate the flame effect system 12, or block activation of the flame effect system 12, in response to determining the altitude of the UAV 10 is below a threshold altitude (e.g., 10 meters, 5 meters, 3 meters, etc.). For example, in response to determining the altitude of the UAV 10 is below the threshold altitude, the controller 26 may instruct the valve to close or block the valve from opening, and deactivate the igniter or block the igniter from activating. In certain embodiments, the controller may deactivate the flame effect system, or block activation of the flame effect system, in response to determining that a difference between the position of the UAV and the expected position of the UAV (e.g., based on a flightpath, etc.) is greater than a threshold distance, and/or determining that a difference between the attitude of the UAV and the expected attitude of the UAV (e.g., based on the flightpath, etc.) is greater than a threshold angle. In addition, in certain embodiments, the controller may deactivate the flame effect system, or block activation of the flame effect system, in response to determining a distance between the UAV (e.g., the nozzle of the flame effect system of the UAV) and a detected object (e.g., detected by the RADAR sensor, the LiDAR sensor, etc.) is less than a threshold distance.

Furthermore, in certain embodiments, the controller 26 is configured to deactivate the flame effect system 12, or block activation of the flame effect system 12, in response to detection of a landing force greater than a threshold landing force. For example, in response to detecting a landing force greater than the threshold landing force, the controller 26 may instruct the valve to close or block the valve from opening, and deactivate the igniter or block the igniter from activating. By way of example, if the UAV lands with a force greater than the threshold landing force (e.g., as monitored by the impact sensor), one component of the flame effect system 12 may shift relative to another component of the flame effect system 12 (e.g., the propellant tank may become disconnected from the fluid path, etc.). Accordingly, in response to detection of a landing force greater than the threshold landing force, the controller may deactivate the flame effect system, or block activation of the flame effect system, until the controller receives a reset command from an operator after inspection of the flame effect system.

FIG. 3 is a schematic view of an embodiment of a flame effect system 12 that may be employed within the UAV of FIG. 1. In the illustrated embodiment, the flame effect system 12 includes a hopper 38 configured to store a powdered fuel 40. The hopper 38 may be formed from any suitable material(s), such as polymeric material(s), metallic material(s), composite material(s), etc. Furthermore, the hopper 38 may have any suitable shape and size (e.g., based on the configuration of the body of the UAV, based on an expected operational duration of the flame effect system 12, etc.). In addition, the hopper 38 may include a hatch configured to selectively open to facilitate filling the hopper 38 with the powdered fuel 40 and to close to contain the powdered fuel 40 within the hopper 38. The powdered fuel 40 may include any suitable type(s) of powder configured to burn in the presence of atmospheric oxygen (e.g., in which the atmospheric oxygen is the only oxidizer). For example, the powdered fuel may not ignite unless a separate oxidizer (e.g., atmospheric oxygen) is provided. In certain embodiments, the powdered fuel 40 is exclusively lycopodium powder. However, other powdered fuels may be used. For example, a powdered fuel may include (e.g., contain) powdered metal(s) (e.g., magnesium, aluminum, etc.), wheat flour, corn starch, coal powder, other suitable type(s) of powder, or a combination thereof.

Furthermore, in the illustrated embodiment, the flame effect system 12 includes a propellant tank 42 configured to store a propellant. The propellant tank 42 may be formed from any suitable material(s), such as polymeric material(s), metallic material(s), composite material(s), etc. Furthermore, the propellant tank 42 may have any suitable shape and size (e.g., based on the configuration of the body of the UAV, based on an expected operational duration of the flame effect system 12, etc.). In certain embodiments, the propellant tank 42 may be a single-use commercially available propellant cartridge. In certain embodiments, the propellant tank may include a connector (e.g., Schrader valve, etc.) configured to facilitate filling and/or refilling the propellant tank with propellant. The propellant may include any suitable type of pressurized propellant (e.g., stored as a liquid and/or gas). For example, in certain embodiments, the propellant is non-flammable and non-oxidizing, such as carbon dioxide or nitrogen. However, in other embodiments, the propellant may be oxidizing, such as air, oxygen, or nitrous oxide.

In addition, in the illustrated embodiment, the flame effect system 12 includes a nozzle 44 configured to expel the powdered fuel 40 into the atmosphere, and the flame effect system 12 includes a fluid path 46 extending from the propellant tank 42 to the nozzle 44. The fluid path 46 may be formed from any suitable material(s), such as polymeric material(s), metallic material(s), composite material(s), etc. Furthermore, the fluid path 46 may have any suitable cross-sectional area and cross-sectional shape (e.g., circular, etc.). In the illustrated embodiment, the cross-sectional area and the cross-sectional shape of the fluid path 46 is the same along the length of the fluid path 46. However, in other embodiments, the cross-sectional area and/or the cross-sectional shape of the fluid path may vary along the length of the fluid path (e.g., the fluid path may have one or more converging-diverging sections, etc.).

In the illustrated embodiment, the flame effect system 12 includes a connector 48 configured to selectively couple the propellant tank 42 to the fluid path 46. For example, in certain embodiments, the connector 48 may include internal threads configured to engage corresponding external threads of the propellant tank 42. In such embodiments, the propellant tank 42 may be coupled to the fluid path 46 by rotating the propellant tank 42 to thread the external threads of the propellant tank 42 into the internal threads of the connector 48. In certain embodiments, the connector 48 may include other suitable connection device(s) (e.g., alone or in combination with the threads), such as latch(es), clamp(s), other suitable connection device(s), or a combination thereof. The connector 48 facilitates removal and replacement of the propellant tank 42 (e.g., when the propellant within the propellant tank 42 is depleted). In certain embodiments, the connector 48 is configured to open the propellant tank 42 upon engagement of the propellant tank 42 with the connector 48. For example, in certain embodiments, a seal may be positioned at an outlet of the propellant tank, and the connector may include a pin configured to pierce the seal upon engagement of the propellant tank with the connector, thereby opening the propellant tank. In certain embodiments, the propellant tank may include a valve (e.g., Schrader valve, etc.) positioned at the outlet of the propellant tank, and the connector may include a protrusion configured to engage the valve in response to engagement of the propellant tank with the connector, thereby opening the propellant tank. While the flame effect system 12 includes the connector 48 in the illustrated embodiment, in other embodiments, the connector may be omitted (e.g., the propellant tank may be fixedly coupled to the fluid path).

The nozzle 44 may be formed from any suitable material(s), such as ceramic material(s), metallic material(s), composite material(s), etc. Because the nozzle 44 is exposed to heat from the flame effect, the nozzle 44 may be formed from material(s) configured to resist the heat from the flame effect. In the illustrated embodiment, the nozzle 44 is coupled to the fluid path 46. However, in other embodiments, the nozzle may be integrally formed with the fluid path (e.g., a nozzle may be formed at the outlet of the fluid path). The nozzle 44 may have any suitable shape (e.g., a circular cross-sectional shape, etc.) and size. In the illustrated embodiment, the nozzle 44 diverges along the direction of flow of the propellant and powdered fuel 40 through the nozzle. However, in other embodiments, the nozzle may converge along the direction of the flow, the nozzle may converge and diverge along the direction of the flow, or the nozzle may have a constant internal cross-sectional area.

As illustrated, the hopper 38 is fluidly coupled to the fluid path 46 at an intersection 50, which is positioned between the propellant tank 42 and the nozzle 44. In the illustrated embodiment, the flame effect system 12 includes a second fluid path 52 fluidly coupling the hopper 38 to the fluid path 46. However, in other embodiments, the hopper may be directly coupled to the fluid path 46. In an embodiment, the hopper 38 is configured to enable the powdered fuel 40 to flow into the fluid path 46 (e.g., through the second fluid path 52) under the influence of gravity. Accordingly, in such an embodiment, the flame effect system 12 does not include any device (e.g., rotating wheel driven by a motor, etc.) configured to drive the powdered fuel 40 into the fluid path 46. As a result, the cost, the weight, and the complexity of the flame effect system 12 may be reduced (e.g., as compared to a flame effect system having a device configured to drive the powdered fuel into the fluid path). Furthermore, certain powdered fuels (e.g., lycopodium powder, etc.) may tend to clump at the intersection 50 (e.g., due to the weight of the powdered fuel within the hopper 38 acting on the powdered fuel within the fluid path 46 at the intersection 50), thereby blocking flow of the powdered fuel through the fluid path 46 until the powdered fuel 40 is fluidized by the flowing propellant. Accordingly, while the propellant is not flowing through the fluid path 46, the powdered fuel 40 may remain, or substantially remain, within the fluid path 46. The propellant tank 42 is configured to expel the propellant through the fluid path 46 to fluidize the powdered fuel 40 at the intersection 50 and to drive the powdered fuel 40 through the nozzle 44. As a result, a combustion reaction may be initiated between the powdered fuel 40 and the oxygen within the atmosphere, thereby generating the flame effect. While the flame effect system 12 does not include any device configured to drive the powdered fuel 40 into the fluid path 46 in the illustrated embodiment, in other embodiments, the flame effect system may include a device (e.g., rotating wheel driven by a motor, etc.) configured to drive the powdered fuel into the fluid path).

In the illustrated embodiment, the flame effect system 12 includes a valve 54 disposed along the fluid path 46 between the propellant tank 42 and the intersection 50. The valve 54 is configured to selectively open to facilitate flow of the propellant through the fluid path 46. In addition, the valve 54 is configured to selectively close to block flow of the propellant through the fluid path 46. In the illustrated embodiment, the valve 54 is communicatively coupled to the controller 26, and the controller 26 is configured to instruct the valve to open and close. While the flame effect system 12 includes the valve 54 in the illustrated embodiment, in other embodiments, the valve may be omitted, and the flame effect system may include a device configured to selectively open and close the propellant tank to selectively facilitate and block flow of the propellant through the fluid path.

In the illustrated embodiment, the flame effect system 12 includes an igniter 56 positioned at the nozzle 44. The igniter 56 is configured to activate to initiate a combustion reaction between the powdered fuel 40 and the oxygen in the atmosphere, thereby generating the flame effect. The igniter 56 may include any suitable ignition device(s) configured to initiate the combustion reaction between the powdered fuel 40 and the oxygen in the atmosphere (e.g., spark igniter, plasma igniter, etc.). While the igniter 56 is positioned at the nozzle 44 in the illustrated embodiment, in other embodiments, the igniter may be positioned proximate to the nozzle (e.g., coupled to the body of the UAV) to ignite the powdered fuel expelled from the nozzle. Furthermore, while the flame effect system 12 includes the igniter 56 in the illustrated embodiment, in other embodiments, the igniter may be omitted. For example, in certain embodiments, the powdered fuel 40 may include one or more components configured to automatically ignite in response to dispersion in the atmosphere.

By way of example, to initiate a flame effect, the controller 26 may first instruct the valve 54 to open, thereby facilitating flow of the propellant through the fluid path 46. As the propellant flows through the fluid path 46, the propellant fluidizes the powdered fuel 40 that collects at the intersection 50, and the propellant drives the fluidized powdered fuel through the fluid path 46 and the nozzle 44. The controller 26 then instructs the igniter 56 to activate, thereby initiating the combustion reaction between the powdered fuel 40 dispersed by the nozzle 44 and the oxygen within the atmosphere. As a result, the flame effect system 12 generates a flame effect. In certain embodiments, the controller 26 may instruct the igniter 56 to activate a selected duration after instructing the valve 54 to open. The selected duration may correspond to the time sufficient for the fluidized powdered fuel 40 to flow from the intersection to an outlet of the nozzle 44. In certain embodiments, the controller 26 may instruct the igniter 56 to activate for a sufficient duration to initiate the combustion reaction between the powdered fuel 40 and the oxygen within the atmosphere. In addition, in certain embodiments, the controller 26 may instruct the valve 54 to open for a selected duration based on a desired duration of the flame effect. Each duration may be stored within the controller 26 and/or input by an operator (e.g., via input to the base station).

In the illustrated embodiment, the flame effect system 12 includes an orifice plate 58 disposed along the second fluid path 52. The orifice plate 58 is configured to control a flow rate of the powdered fuel 40 from the hopper 38 into the fluid path 46. In certain embodiments, the orifice plate 58 has a fixed orifice area, and the orifice area may be selected based on a desired size of the flame effect. For example, a smaller orifice area may reduce the flow rate of the powdered fuel into the fluid path, thereby reducing the size of the flame effect, and a larger orifice area may increase the flow rate of the powdered fuel into the fluid path, thereby increasing the size of the flame effect. As discussed in detail below, in certain embodiments, the orifice area of the orifice plate may be adjustable to control the size of the flame effect. In certain embodiments, the orifice plate may be omitted. In such embodiments, the flow rate of the powdered fuel into the fluid path may be established based on an outlet area of the hopper and/or a cross-sectional area of the second fluid path.

In certain embodiments, the valve 54 is adjustable to control a flow rate of the propellant through the fluid path 46. For example, the valve may include an iris valve, a ball valve, or another suitable type of valve. The controller 26 may control the valve 54 to control the flow rate of the propellant through the fluid path 46. For example, the controller 26 may control the valve 54 to increase the flow rate of the propellant while the valve is open to establish a longer flame effect, and the controller 26 may control the valve 54 to decrease the flow rate of the propellant while the valve is open to establish a shorter flame effect. While an adjustable valve is disclosed above, in certain embodiments, the valve may only transition between the closed position and a fixed (e.g., non-adjustable) open position.

In certain embodiments, the orifice plate 58 is adjustable to control the flow of the powdered fuel 40 from the hopper 38 into the fluid path 46. For example, the orifice plate 58 may include an iris valve or another suitable type of valve, and the valve may control the orifice area of the orifice plate 58. In the illustrated embodiment, the orifice plate 58 includes an actuator 60 configured to control the valve, and the controller 26 is communicatively coupled to the actuator 60 of the orifice plate 58. The controller 26 may control the actuator 60 to control the orifice area, thereby controlling the flow rate of the powdered fuel 40 into the fluid path 46. For example, the controller 26 may control the orifice plate 58 to increase the orifice area, thereby increasing the flow rate of the powdered fuel 40 into the fluid path 46. As a result, the size of the flame effect may increase. In addition, the controller 26 may control the orifice plate 58 to decrease the orifice area, thereby reducing the flow rate of the powdered fuel 40 into the fluid path 46. As a result, the size of the flame effect may decrease. While an adjustable orifice plate is disclosed above, in certain embodiments, the orifice area of the orifice plate may be fixed. In such embodiments, the actuator may be omitted. In certain embodiments, the orifice plate may be interchangeable, thereby enabling an operator to select an orifice plate having a desired orifice area and to dispose the orifice plate along the second fluid path 52.

In certain embodiments, the nozzle 44 is adjustable to control dispersion of the powdered fuel 40 into the atmosphere. For example, an outlet shape and/or an outlet area of the nozzle 44 may be adjustable. In the illustrated embodiment, the nozzle 44 includes an actuator 62 (e.g., nozzle actuator) configured to adjust the outlet shape and/or the outlet area, and the controller 26 is communicatively coupled to the actuator 62 of the nozzle 44. The controller 26 may control the actuator 62 to control the outlet shape and/or the outlet area of the nozzle 44, thereby controlling the dispersion of the powdered fuel 40 into the atmosphere. While an adjustable nozzle is disclosed above, in certain embodiments, the outlet shape and the outlet area of the nozzle may be fixed. In such embodiments, the actuator may be omitted. In certain embodiments, the nozzle may be interchangeable, thereby enabling an operator to select a nozzle having a desired outlet shape and/or outlet area and to couple the nozzle to the fluid path.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A flame effect system for an unmanned aerial vehicle (UAV), the flame effect system comprising:
a hopper configured to store a powdered fuel;
a propellant tank configured to store a propellant;
a nozzle configured to expel the powdered fuel into an atmosphere; and
a fluid path extending from the propellant tank to the nozzle, wherein the hopper is fluidly coupled to the fluid path at an intersection between the propellant tank and the nozzle, the hopper is configured to enable the powdered fuel to flow into the fluid path, and the propellant tank is configured to expel the propellant through the fluid path to fluidize the powdered fuel within the fluid path and to drive the fluidized powdered fuel through the nozzle.

2. The flame effect system of claim 1, comprising an igniter positioned at or proximate to the nozzle, wherein the igniter is configured to activate to initiate a combustion reaction between the fluidized powdered fuel and oxygen in the atmosphere.

3. The flame effect system of claim 1, comprising a valve disposed along the fluid path between the propellant tank and the intersection, wherein the valve is configured to selectively open to facilitate flow of the propellant through the fluid path.

4. The flame effect system of claim 3, wherein the valve is adjustable to control a flow rate of the propellant through the fluid path.

5. The flame effect system of claim 1, wherein the powdered fuel comprises lycopodium powder, the propellant comprises carbon dioxide, or a combination thereof.

6. The flame effect system of claim 1, wherein the hopper is configured to enable the powdered fuel to flow into the fluid path under the influence of gravity.

7. The flame effect system of claim 1, comprising:
a second fluid path fluidly coupling the hopper to the fluid path; and
an orifice plate disposed along the second fluid path, wherein the orifice plate is configured to control a flow rate of the powdered fuel into the fluid path.

8. The flame effect system of claim 1, wherein an outlet shape, an outlet area, or a combination thereof, of the nozzle is adjustable.

9. An unmanned aerial vehicle (UAV), comprising:
a body;
at least one electric motor coupled to the body;
at least one propeller coupled to the at least one electric motor;
a battery coupled to the body and electrically coupled to the at least one electric motor; and
a flame effect system coupled to the body, wherein the flame effect system comprises:
a hopper configured to store a powdered fuel;
a propellant tank configured to store a propellant;
a nozzle configured to expel the powdered fuel into an atmosphere; and
a fluid path extending from the propellant tank to the nozzle, wherein the hopper is fluidly coupled to the fluid path at an intersection between the propellant tank and the nozzle, the hopper is configured to enable the powdered fuel to flow into the fluid path, and the propellant tank is configured to expel the propellant through the fluid path to fluidize the powdered fuel within the fluid path and to drive the fluidized powdered fuel through the nozzle.

10. The UAV of claim 9, wherein the flame effect system comprises an igniter positioned at or proximate to the nozzle, and the igniter is configured to activate to initiate a combustion reaction between the fluidized powdered fuel and oxygen in the atmosphere.

11. The UAV of claim 9, wherein the flame effect system comprises a valve disposed along the fluid path between the propellant tank and the intersection, and the valve is configured to selectively open to facilitate flow of the propellant through the fluid path.

12. The UAV of claim 9, wherein the powdered fuel comprises lycopodium powder, the propellant comprises carbon dioxide, or a combination thereof.

13. The UAV of claim 9, wherein the hopper is configured to enable the powdered fuel to flow into the fluid path under the influence of gravity.

14. The UAV of claim 9, wherein the flame effect system comprises:
a second fluid path fluidly coupling the hopper to the fluid path; and
an orifice plate disposed along the second fluid path, wherein the orifice plate is configured to control a flow rate of the powdered fuel into the fluid path.

15. A flame effect system for an unmanned aerial vehicle (UAV), the flame effect system comprising:
a hopper configured to store a powdered fuel;
a propellant tank configured to store a propellant;
a nozzle configured to expel the powdered fuel into an atmosphere;
a fluid path extending from the propellant tank to the nozzle, wherein the hopper is fluidly coupled to the fluid path at an intersection between the propellant tank and the nozzle, and the hopper is configured to enable the powdered fuel to flow into the fluid path;
a valve disposed along the fluid path between the propellant tank and the intersection, wherein the valve is configured to selectively open to facilitate flow of the propellant through the fluid path to fluidize the powdered fuel within the fluid path and to drive the fluidized powdered fuel through the nozzle;
an igniter positioned at or proximate to the nozzle, wherein the igniter is configured to activate to initiate a combustion reaction between the fluidized powdered fuel and oxygen in the atmosphere; and
a controller communicatively coupled to the valve and to the igniter, wherein the controller comprises a memory and a processor, and the controller is configured to instruct the valve to open and the igniter to activate to initiate the combustion reaction.

16. The flame effect system of claim 15, comprising a nozzle actuator configured to adjust an outlet shape, an outlet area, or a combination thereof, of the nozzle, wherein the nozzle actuator is communicatively coupled to the controller, and the controller is configured to control the nozzle actuator.

17. The flame effect system of claim 15, wherein the hopper is configured to enable the powdered fuel to flow into the fluid path under the influence of gravity.

18. The flame effect system of claim 15, comprising:
a second fluid path fluidly coupling the hopper to the fluid path; and
an orifice plate disposed along the second fluid path, wherein the orifice plate is configured to control a flow rate of the powdered fuel into the fluid path;
wherein the orifice plate is communicatively coupled to the controller, and the controller is configured to control an orifice area of the orifice plate to control the flow rate of the powdered fuel into the fluid path.

19. The flame effect system of claim 15, wherein the controller is configured to instruct the valve to close and the igniter to deactivate in response to determining the UAV is below a threshold altitude.

20. The flame effect system of claim 15, wherein the controller is configured to instruct the valve to close and the igniter to deactivate in response to detection of a landing force greater than a threshold landing force.
